(19) United States
(12) Patent Application Publication
(10) Pub. No.: US 2013/0054326 A1
(43) Pub. Date: Feb. 28, 2013

(54) Relationship Rewards

(71) Applicants: Erik Stephen Ross, Charlotte, NC (US); James A. Greco, Elkton, MD (US)

(72) Inventors: Erik Stephen Ross, Charlotte, NC (US); James A. Greco, Elkton, MD (US)

(73) Assignee: BANK OF AMERICA CORPORATION, Charlotte, NC (US)

(21) Appl. No.: 13/216,438

(22) Filed: Aug. 24, 2011

(51) Int. Cl. G06Q 30/00

(52) U.S. Cl. 705/14.17; 705/14.25

(57) ABSTRACT

An enhanced relationship server may analyze the relationship of an individual, group, and/or organization with respect to an entity. Based on this analysis, the enhanced relationship server may determine a relationship level of the individual, group, and/or organization with respect to the entity. The determined relationship level may be used to provide an appropriate incentive to maintain a relationship with the entity and/or strengthen an existing relationship with the entity. In addition, the enhanced relationship server may determine a social network of the individual, group, and/or organization and may use the social network as an aid in determining the appropriate reward/incentive.

### TECHNICAL FIELD

Aspects of the invention generally relate to ways in which an entity may incentivize various levels of a relationship with the entity. In particular, an enhanced relationship server may be used to determine which of various reward levels may be appropriate for the relationship level associated with individuals, groups, and/or organizations.

### BACKGROUND

Individuals, groups, and/or organizations no longer base their decisions about purchases primarily on remaining loyal to a particular business entity. Rather, they are increasingly looking for the best deals when purchasing products and/or services.

Therefore, these entities (e.g., companies, firms, and other organizations) are constantly looking for new ways to attract and maintain a customer base. For instance, a company may decide that advertising discounts on certain products during a predetermined time period results in increased annual profits.

However, current strategies at attracting and maintaining customers are not adequate to give entities the competitive advantage they need in order to sufficiently outperform their competitors.

Thus, there is a need for new strategies for attracting and maintaining customers.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, non-transitory computer readable media, and apparatuses tying the size of a customer reward to a depth of a relationship (e.g., relationship level) maintained by the customer to the entity offering the reward. An entity may reward an individual, group, and/or organization with cash back, redeemable points, discounts, interest rate incentives, etc. when the entity determines that the individual, group, and/or organization establishes a first relationship and/or additional relationships with the entity.

Other aspects of the disclosure relate to an enhanced relationship server that may analyze data related to an individual, group, and/or organization in order to determine the extent of a relationship maintained by the individual, group, and/or organization. The server may also determine an appropriate reward and/or incentive level for the determined relationship.

Aspects of the disclosure may be provided in a computer-readable medium having computer-executable instructions that, when executed, cause a computer or other apparatus to perform one or more of the process steps described herein.

Aspects of the disclosure relate to a non-transitory computer-readable storage medium having computer-executable program instructions stored thereon that when executed by a processor, cause the processor to perform steps comprising: (i) analyzing information related to an individual over a predetermined time period; (ii) based on the analysis, determining a relationship level of the individual with an entity; (iii) receiving an indicator identifying a change in relationship between the individual and the entity; (iv) based on the indicator, updating the relationship level; and (v) based on the updated relationship level, transmitting a first reward message to the individual.

Additional aspects of the disclosure relate to a computer-assisted method comprising: using a processor associated with a computer, determining members of a social network, wherein each of the members share a common attribute; using the processor, analyzing transaction data associated with each of the members; using the processor and based on the analysis, determining a relationship level for each of the members; using the processor, based on the relationship levels, determining a group reward for each of the members of the social network; and using a communication module associated with the computer, causing providing of the group reward to each of the members of the social network.

Additional aspects of the disclosure relate to an apparatus comprising: a processor; and a memory storing computer-readable instructions that, when executed by the processor, cause the apparatus at least to perform: receiving a first indicator that an individual has formed an initial relationship with an entity; based on the first indicator, determining a relationship level of the individual with respect to the entity; receiving a second indicator that the individual has formed a second relationship with the entity; based on the second indicator, updating the relationship level of the individual with respect to the entity; based on the updated relationship level, determining a multiplier for a number of reward points for the individual; and transmitting the multiplied reward points to the individual.

### BRIEF DESCRIPTION OF THE DRAWINGS

The example embodiments are illustrated by way of example in the accompanying figures in which like reference numerals indicate similar elements and in which:

FIG. 1 shows an illustrative operating environment in which various aspects of the disclosure may be implemented.

FIG. 2 is an illustrative block diagram of workstations and servers that may be used to implement the processes and functions of one or more aspects of the present disclosure.

FIG. 3 is an example flow diagram of steps performed by an enhanced relationship server in accordance with one or more aspects of the disclosure.

### DETAILED DESCRIPTION

Business entities (e.g., financial institutions, retail stores, private firms, etc.) struggle with attracting and maintaining a customer base. Therefore, the example embodiments of this disclosure provide novel methodologies to incentivize and/or reward an individual, group, and/or organization for maintaining and/or increasing the extent of a relationship (i.e., an increase in the relationship level) with an entity offering products and/or services.

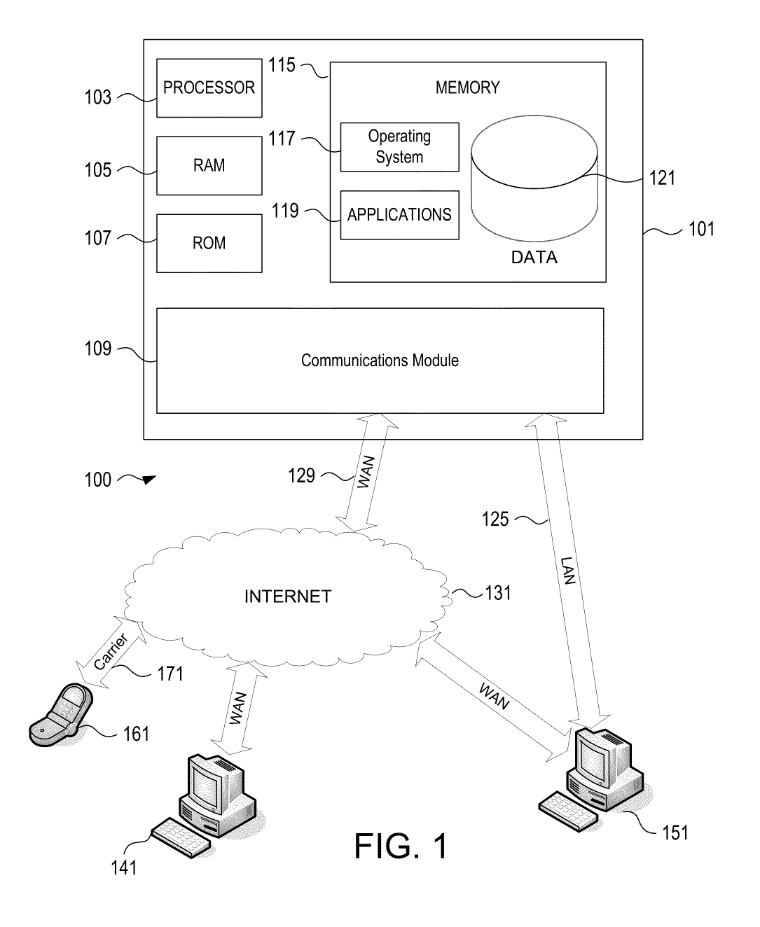

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Processor 103 and its associated components may allow the computing device 101 to run a series of computer-readable instructions related to analyzing customer data to determine if a reward is appropriate. Processor 103 may also direct computing device 101 to transmit a predetermined reward to an individual, group, and/or organization based on this analysis.

Computing device 101 typically includes a variety of computer readable media. Computer readable media may be any available media that may be accessed by computing device 101 and include both volatile and nonvolatile media, removable and non-removable media. By way of example, and not limitation, computer-readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more applications representing the application data stored in RAM 105 while the computing device 101 is on and corresponding software applications (e.g., software tasks) are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware. 28 Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 125 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications (e.g., for transmitting reward information, monitoring relationship levels, sending information to potential customers/customers about products/services offered by an entity, etc.). In addition, the application programs 119 may include computer executable instructions for invoking user functionality related to determining a reward for establishing a predetermined relationship level.

Embodiments of the disclosure may include forms of computer-readable media. Computer-readable media include any available media that can be accessed by computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor 103 on computing device 101. Such a processor may execute computer-executable instructions stored on a computer-readable medium.

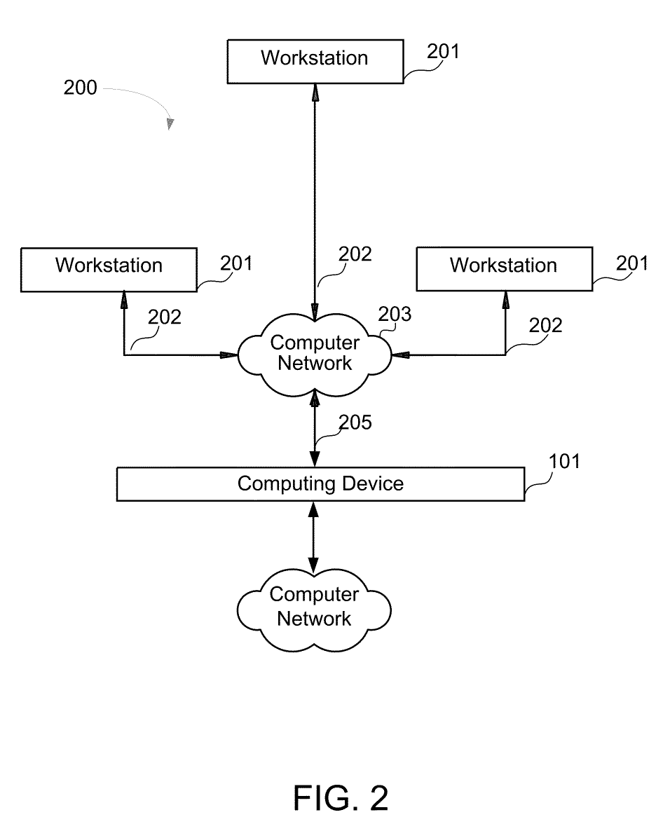

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to computing device 101. Workstations 201 may include many of the same hardware/software components as computing device 101. In some embodiments, workstations 201 may represent data stores for storing customer data accessed and used by computing device 101. In other embodiments, workstations 201 may represent various user terminals for accessing computing device 101. In system 200, computing device 101 may be any suitable server, processor, computer, or data processing device, or combination of the same. Computing device 101 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and computing device 101, such as network links, dial-up links, wireless links, hard-wired links, etc.

The steps that follow in the Figures may be implemented by one or more of the components in FIGS. 1 and 2 and/or other components, including other computing devices.

In accordance with various aspects of the disclosure, methods, computer-readable media, and apparatuses are disclosed that allow an entity, such as a company, financial organization, bank, credit union, government agency, university, individual, group, etc., to implement methodologies for maintaining and/or deepening a relationship with the entity.

To implement the rewards solution, an entity (e.g., a financial organization) may use the computing device 101 (hereinafter, enhanced relationship server 101) configured to run computer-executable program instructions related to each step of the relationship management and rewards process. If the entity implementing the enhanced relationship server 101 is a financial organization (e.g., a bank), the bank may already possess credit card data, checking/savings account data, and/or other types of financial and/or transaction data about each of its customers. The bank may then use the enhanced relationship server 101 to analyze this data and determine the extent of a relationship with the bank. In analyzing the data, the bank may apply predefined business logic rules (e.g., in the form of a computer algorithm stored on a computer-readable medium) to determine what, if any, reward may be justified for the determined relationship level.

Enhanced relationship server 101 may quantify the relationship associated with the entity by establishing various relationship levels. In certain aspects, a relationship level may represent a level of involvement of a potential customer and/or actual customer with an entity. A customer/potential customer may represent an individual, group, and/or organization. For instance, if the entity is a financial institution, a potential customer/customer may achieve a first or minimum relationship level by various indicators, including speaking with a financial advisor associated with the financial institution to open a bank account (e.g., savings, checking, brokerage, etc.), inquire about loans (e.g., auto, home, etc.), view a home owned by the financial institution with an intent to purchase the home, obtain information regarding interest rates offered by the financial institution, etc. A higher relationship level may be achieved by various indicators, including opening multiple bank accounts (e.g., savings, checking, etc.), by signing up for a credit card (e.g., personal credit card, merchant services credit card, etc.) issued by the financial institution, by buying an insurance product offered by the financial institution, by establishing a commercial relationship (e.g., a payroll offering for a business, etc.) with the financial institution, by establishing a commercial partnership with business partners of the financial institution, and/or by taking out a car and/or home mortgage loan with the financial institution, among other things.

Enhanced relationship server 101 may establish progressively higher relationship levels between a potential customer/customer and the financial institution when the potential customer/customer takes a progressively higher number of the above actions within a predetermined time period. It should be noted that one of ordinary skill in the art will recognize that enhanced relationship server 101 may generate different sets of relationship levels based on a given scenario.

Progressively higher relationship levels may result in progressively higher rewards (e.g., a geometric increase of rewards, etc.) offered to a potential customer/customer of the entity. For instance, if enhanced relationship server 101 offers a cash reward of $50 when a customer speaks to a financial advisor associated with an entity, the reward may increase to $100 when the customer opens a bank account with the entity. As another example, enhanced relationship server 101 may increase a base reward by a progressively increasing multiplier for new relationship levels achieved by the potential customer/customer. In particular, assume that a customer receives 500 reward points for taking out a home mortgage loan with a bank. By taking out a credit card with the bank within six months of taking out the home mortgage loan, enhanced relationship server 101 may multiply the number of reward points by a factor of 2 (i.e., 1000 reward points). If, in addition to taking out the home mortgage loan and the credit card with the bank, this customer opens a brokerage account with the bank within six months of the other two events, enhanced relationship server 101 may multiply the number of reward points by a factor of 5 (i.e., resulting in 5000 total reward points). The multiplier for the reward points may also be based on the total value of new purchases made via a credit card and/or bank accounts associated with the bank.

As another example, a base number of reward points given to a customer (e.g., 10 points for signing up for a credit card) by the bank may be multiplied by a factor of 2 when the customer opens a saving account, may be multiplied by a factor of 3 when the customer opens a demand deposit account (DDA) and a savings account, may be multiplied by a factor of 5 for other types of accounts, and/or may be multiplied by a factor of 10 for taking out a home loan with the bank.

Enhanced relationship server 101 may offer various rewards for establishing and/or deepening a relationship with an entity. These rewards may include a cash reward, an increase in the number of rewards points (e.g., points redeemable either for cash and/or other products/services offered via a credit card, etc.), a discount at a third-party vendor with whom the entity has partnered, and/or interest rate incentives (e.g., discounts on an interest rate associated with a home, auto, etc. loan and/or an increase in an interest rate associated with a bank account maintained by an entity administering the rewards program, etc.).

In certain aspects, the entity managing the enhanced relationship server 101 may also receive various types of information about relationships maintained and/or newly established for potential customers/customers. This information may relate to various aspects of the relationship of any potential customer/customer with the entity, including the amount, type, location, and/or number of purchases made at the entity over a predetermined time period by the customer/potential customer, the location of the potential customer/customer, a risk score (e.g., a score such as a credit score that may indicate the risk associated with giving credit, etc.) of the potential customer/customer, the amount of loans/credit offered by the entity to the customer/potential customer, the frequency of purchases made by the potential customer/customer through credit established by the entity, and/or an account balance of the potential customer/customer at the entity, among other things. By analyzing the information related to the relationship, enhanced relationship server 101 may determine a relationship level and a reward corresponding to the determined relationship level of the potential customer/customer associated with the entity.

In certain example aspects, enhanced relationship server 101 may analyze transaction and other account data associated with customers (e.g., when the entity managing the enhanced relationship server 101 is a financial institution) to determine the types, location, and/or number of purchases made at various third party vendors. This data may be analyzed to determine a relationship level and an associated reward level for any given customer. This data may also be used to steer customers to commercial partners of the entity managing enhanced relationship server 101.

For instance, if the entity managing enhanced relationship server 101 is a bank, the bank may establish partnerships with specific retail stores and/or other businesses. After examining transaction data (e.g., data associated with purchases made through a credit card, checking account, etc.) of various customers of the bank, the enhanced relationship server 101 associated with the bank may determine that at least some of the customers have been purchasing items at competitors of businesses that have partnered with the bank. In this scenario, the enhanced relationship server 101 may inform these customers of offerings, sales, discounts, etc. through the business partners to help steer customers to the business partners.

In addition, the enhanced relationship server 101 may offer rewards (such as those mentioned above for achieving various relationship levels) to the customers to incentivize doing business with business partners of the bank. The business partners may then realize more visibility with customers of the bank and may ultimately benefit from more sales as a result of this visibility. The business partner of the bank may also return at least a portion of the increased sales revenue to the bank in return for increased exposure to the bank's customer base.

Finally, the enhanced relationship server 101 may return at least a portion of the funds provided from the business partners to customers of the bank in the form of cash rewards, discounts on products from third party vendors, interest rate incentives, rewards points, etc. In this way, the enhanced relationship server 101 may allow the bank, its business partners, and customers of the bank to all benefit from this relationship management and rewards program.

In some embodiments, the size and/or type of reward offered by an entity to potential customers/customers of the entity may also be determined by the relationship level of the potential customer/customer at business partners of the entity. For instance, to extend the example of a bank discussed above, the enhanced relationship server 101 may offer a base reward (e.g., 20 rewards points) to a customer for purchases during a predetermined time period (e.g., a month) totaling a minimum level (e.g., less than $10) at a retail store partnered with the bank. Similarly, the enhanced relationship server 101 may offer a larger reward (e.g., 40 rewards points) to this customer for purchases totaling an intermediate level (e.g., $10-$50) during this time period. Finally, the enhanced relationship server 101 may offer an even larger reward (e.g., 80 rewards points) to this customer for purchases totaling a high level (e.g., greater than $50) during this time period.

In some embodiments, the rewards program outlined in this disclosure may be made available to certain segments of the population. For instance, enhanced relationship server 101 may target the mass affluent segment of the population based on a minimum balance within a bank account maintained by the entity (e.g., a bank) managing enhanced relationship server 101 and/or the level of assets owned by the potential customer/customer, as determined by the entity. In other example embodiments, the enhanced relationship server 101 may target anyone falling between and including the top tier of the mass market and the mass affluent. In yet other example embodiments, the rewards program may be offered based on the risk score of the potential customer/customer and/or based on the amount of funds being channeled to competitors of the entity (e.g., if the entity is a bank, then the bank may monitor the amount of funds being channeled to other banks)

In other aspects, the rewards program offered by an entity may include short-term offers. For example, enhanced relationship server 101 may entice an affluent customer to speak with a financial advisor associated with the entity by offering a reward points multiplier of 2 (e.g., doubling your reward points) for a predetermined time period (e.g., 2 months). The points multiplier may be extended and/or increased if the affluent customer enters into a deal (e.g., buys a product, etc.) with the entity after speaking with the financial advisor.

In yet other example aspects, enhanced relationship server 101 may monitor users in a social networking environment to achieve a common goal. In particular, enhanced relationship server 101 may facilitate a social network environment for analyzing transaction and other financial data associated with each member of the social network. For example, enhanced relationship server 101 may first establish or otherwise determine a social network related to an individual associated with a given entity relationship level. The members of the individual's social network may be based on any number of attributes that the individual may share with the members. For instance, if enhanced relationship server 101 is seeking to establish a deeper relationship with the individual based on the individual's desire for purchasing a new home, the individual's social network may include other individuals that also have an interest in purchasing a new home. Also, enhanced relationship server 101 may port the social network of a given individual from social networking platforms such as Facebook™, Twitter™, etc. In yet other embodiments, the social network of an individual may be established by direct feedback from the individual.

Once established, the social network of the individual may be used to deepen the relationship (e.g., increase the relationship level, etc.) of each individual member with an entity. For instance, enhanced relationship server 101 may give each member of an individual's social network access to some or all of the transaction and/or other data used by enhanced relationship server 101 to assess the relationship level of the individual. Enhanced relationship server 101 may electronically provide access to this information, such as, for example, via a webserver, an online banking interface, text message, and/or some other type of message. Each member of the social network may be permitted to send messages (e.g., text, audio, video, and/or a combination thereof) to the individual and/or other members for advice on increasing a relationship level with the entity. In some aspects, enhanced relationship server 101 may implement a referral program that incentivizes (e.g., through cash rewards, points, interest rate incentives, etc.) the ability of one member to deepen a relationship level of other members with the entity.

In other embodiments, enhanced relationship server 101 may include individuals, groups, and/or organizations with the same or similar relationship level and/or interests into a single social network. In this case, enhanced relationship server 101 may generate a group reward by taking into account the relationship level of each member of the social network. Thus, in this implementation, a low relationship level by any member of the social network may result in a lower relationship rating for all members of the social network, thereby reducing any potential reward and/or eliminating the reward completely for the entire group. In this way, each member of the group may feel the peer pressure of other members, given the negative consequences of a low relationship level for all members of the group.

For example, server 101 may assign a relationship level over a predetermined time period for each member of the social network with respect to a given entity. The relationship level of each member of the social network may then be summed and averaged to determine which one of multiple reward categories may apply to the group (e.g., no reward category, small reward category, medium reward category, and/or big reward category). As an example, consider a case when an entity quantifies the relationship level of each potential customer/customer on a scale from 1 to 10, with 1 indicating a very low relationship level and 10 indicating a very high relationship level. A relationship level may be low when the potential customer/customer has only a few relationships with the entity. For example, when the entity is a bank, a low relationship level may occur when the potential customer/customer has contacted a financial advisor associated with the bank and does not have any other association with the bank. In addition, a relationship level may be low when the account balances, loan values, etc. associated with the customer and the bank are below a predetermined threshold. Other the other hand, a relationship level may be high when the potential customer/customer has many relationships with the entity. Again, when the entity is a bank, a high relationship level may occur when the potential customer/customer has several bank accounts, a mortgage loan, and a credit card with the bank. In addition, a high relationship level may occur when one of more of the financial products that associates the customer with the bank are valued above a predetermined threshold.

As an example, when examining the relationship level of each member of the social network, server 101 may transmit no reward to each member for an average group relationship level that is between 1 and 3 (e.g., no reward category), a reward of 20 reward points for an average relationship level that is between 3.01 and 6 (e.g., small reward category), a reward of 40 reward points for an average group relationship level that is between 6.01 and 9 (e.g. medium reward category), and a reward of 120 reward points for an average group relationship level that is greater than 9 (e.g., big reward category). Additionally, each member may receive a bonus reward (e.g., an additional 40 reward points, etc.) when each member of the social network performs achieves a predetermined relationship level (e.g., each member achieves a relationship level of 5 or higher during a given month).

In certain example aspects, an entity may represent a given relationship level in any number of ways, including through the use of a numerical scale, a pictorial representation, icons, etc. For example, an entity may use a scale of 1 to 10 to represent various relationship levels with the entity. In this example, a relationship level between 1 and 3 may indicate very little relationship between an individual, group, and/or organization and the entity. A relationship level between 3.01 and 6 may indicate an intermediate level of relationship, and a relationship level higher than 6 may indicate a high level of relationship.

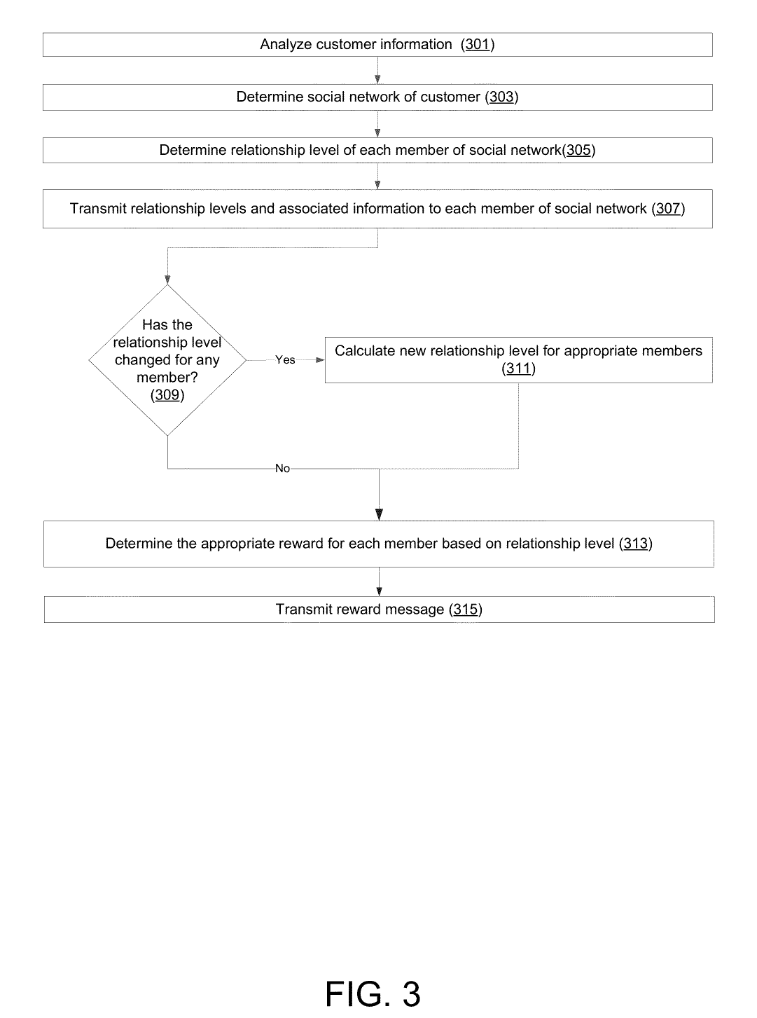

FIG. 3 shows an example flow diagram of the relationship management and rewards process implemented by enhanced relationship server 101, in accordance with at least one aspect of the disclosure. The steps may be rearranged, one or more steps may be added, one or more steps may be omitted, and one or more steps may be repeated. The process may start out at step 301 where the enhanced relationship server 101 may analyze various types of customer information (e.g., transaction data, location data, etc.). The enhanced relationship server 101 may then determine a social network of the customer in step 303. As mentioned above, server 101 may determine the social network in a number of ways, including through social network websites accessed by the customer, by evaluating characteristics of the customer, and/or through direct feedback from the customer.

The process may then move to step 305 where server 101 may determine a relationship level of each member of the social network. As mentioned before, the relationship level may be quantified in any number of ways, including through the use of a numerical scale, symbols, icons, etc.

Then, in step 307, server 101 may periodically transmit the determined relationship levels and associated information to each member of the social network. For instance, server 101 may transmit a message to the customer and/or a customer's social network via email, SMS, via an interface associated with online banking, etc. Then one or more members of the social network may change their relationship status with the entity managing the enhanced relationship server 101.

The process may then move to step 309 where the enhanced relationship server 101 may reanalyze data associated with each member of the social network to determine if any member's relationship level has changed. If the relationship level of at least one member of the social network has changed, server 101 may calculate a new relationship level for the appropriate members in step 311.

If the relationship level of any member of the social network has not changed, server 101 may determine the appropriate reward for each member of the social network in step 313. The reward may or might not be the same for each member. The server 101 may consider the relationship level of each member when providing a reward for that member. Also, after updating the relationship levels for one or more members in step 311, the process may also move to step 313. As mentioned before, the size and/or type of the reward may be based on a variety of factors. For example, if the entity managing enhanced relationship server 101 is a bank, the size and/or type of reward may be based on how many bank accounts the customer has opened with the bank (e.g., no bank accounts=low relationship level, 1-2 bank accounts=average relationship level, greater than 2 bank accounts=high relationship level), the amount of money in each of those accounts (e.g., less than $10000=low relationship level, $10000-20000=average relationship level, greater than $20000=high relationship level), the number and value of purchases made with business partners of the bank (e.g., less than $10000=low relationship level, $10000-20000=average relationship level, greater than $20000=high relationship level), and/or the number of credit cards taken through the bank by the customer (e.g., no credit cards=low relationship level, 1-2 credit cards=average relationship level, greater than 2 credit cards=high relationship level), among other things. Each of these factors may be combined to arrive at an aggregate relationship level that is quantified on a scale (e.g., a scale from 1 to 10).

Finally, in step 315, the enhanced relationship server 101 may transmit information regarding the nature of the reward (e.g., cash, discount, interest rate incentive, etc.). This congratulatory message may be transmitted both to the customer and to his social network.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A non-transitory computer-readable storage medium having computer-executable program instructions stored thereon that when executed by a processor, cause the processor to perform steps comprising:
(i) analyzing information related to an individual over a predetermined time period;
(ii) based on the analysis, determining a relationship level of the individual with an entity;
(iii) receiving an indicator identifying a change in relationship between the individual and the entity;
(iv) based on the indicator, updating the relationship level; and
(v) based on the updated relationship level, transmitting a first reward message to the individual.

2. The computer-readable storage medium of claim 1, wherein the processor further performs:
determining a social network associated with the individual.

3. The computer-readable storage medium of claim 2, wherein the social network is determined by accessing a social network website maintained by the individual.

4. The computer-readable storage medium of claim 2, wherein the processor further performs:
determining a plurality of relationship levels, wherein each of the plurality of relationship levels is associated with each member of the social network.

5. The computer-readable storage medium of claim 4, wherein the first reward message is further based on an average value of the plurality of relationship levels.

6. The computer-readable storage medium of claim 4, wherein the processor further performs:
transmitting the plurality of relationship levels and associated data to each member of the social network.

7. The computer-readable storage medium of claim 6, wherein the associated data comprises data related to ways in which each member of the social network has a relationship with the entity.

8. The computer-readable storage medium of claim 1, wherein the first reward message is chosen from the group consisting of: a cash reward message, reward points message, an interest rate incentive message, and a discount at a third party vendor message.

9. The computer-readable storage medium of claim 1, wherein the processor further performs: analyzing spending characteristics of the individual at business partners of the entity.

10. The computer-readable storage medium of claim 1, wherein the processor further performs: processing the information to determine that the individual has achieved the relationship level when the individual contacts a financial advisor associated with the entity.

11. The computer-readable storage medium of claim 1, wherein the processor further performs: processing the information to determine that the individual has achieved the relationship level when the individual opens a bank account with the entity.

12. The computer-readable storage medium of claim 1, wherein the information comprises transaction and other account data associated with the individual.

13. The computer-readable medium of claim 1, wherein the processor further performs:
based on the relationship level, transmitting a second reward message to the individual.

14. A computer-assisted method comprising:
using a processor associated with a computer, determining members of a social network, wherein each of the members share a common attribute;
using the processor, analyzing transaction data associated with each of the members;
using the processor and based on the analysis, determining a relationship level for each of the members;
using the processor, based on the relationship levels, determining a group reward for each of the members of the social network; and
using a communication module associated with the computer, causing providing of the group reward to each of the members of the social network.

15. The computer-assisted method of claim 14, wherein the group reward is chosen from the group consisting of: a cash reward, reward points, an interest rate incentive, and a discount at a third party vendor.

16. The computer-assisted method of claim 14, wherein the transaction data comprises credit card, checking account, and savings account transaction data.

17. An apparatus comprising:
a processor; and
a memory storing computer-readable instructions that, when executed by the processor, cause the apparatus at least to perform:
receiving a first indicator that an individual has formed an initial relationship with an entity;
based on the first indicator, determining a relationship level of the individual with respect to the entity;
receiving a second indicator that the individual has formed a second relationship with the entity;
based on the second indicator, updating the relationship level of the individual with respect to the entity;
based on the updated relationship level, determining a multiplier for a number of reward points for the individual; and
transmitting the multiplied reward points to the individual.

18. The apparatus of claim 17, wherein the first indicator comprises an indicator that the individual has opened a first bank account with the entity.

19. The apparatus of claim 18, wherein the second indicator comprises an indicator that the individual has opened a second bank account with the entity.

20. The apparatus of claim 19, wherein the multiplier is further determined by an account balance of the first and the second bank accounts.
